(19) United States
(12) Patent Application Publication
(10) Pub. No.: US 2026/0264275 A1
(43) Pub. Date: Sep. 10, 2026

(54) CABLE PROTECTOR RING

(71) Applicant: KUKA Deutschland GmbH, Augsburg (DE)

(72) Inventor: Stefan Karlinger, Augsburg (DE)

(73) Assignee: KUKA Deutschland GmbH, Augsburg (DE)

(21) Appl. No.: 18/875,461

(22) PCT Filed: Jul. 18, 2023
(86) PCT No.: PCT/EP2023/069917

§ 371 Date: Dec. 16, 2024

(30) Foreign Application Priority Data
Aug. 2, 2022 (DE) 10 2022 119 299.7

(51) Int. Cl. B25J 19/00; F16L 57/06

(52) U.S. Cl. CPC B25J 19/0075; B25J 19/0025; F16L 57/06

(57) ABSTRACT

A cable protector ring for a power supply line on a robot includes at least one first part-shell and at least one second part-shell, wherein the part shells, when assembled, complement each other to form a first ring body of the cable protector ring. The first ring body includes an inner jacket wall that circumferentially surrounds the power supply line when the cable protector ring is arranged in its installed position on the power supply line. The first ring body includes a circumferential seat surface that is arranged on its outer jacket wall and on which a one-piece, circumferentially closed second ring body is mounted.

### CROSS-REFERENCE TO RELATED APPLICATIONS

This application is a national phase application under 35 U.S.C. § 371 of International Patent Application No. PCT/EP2023/069917, filed Jul. 18, 2023 (pending), which claims the benefit of priority to German Patent Application No. DE 10 2022 119 299.7, filed Aug. 2, 2022, the disclosures of which are incorporated by reference herein in their entirety.

### TECHNICAL FIELD

The invention relates to a cable protector ring for a power supply line on a robot arm, comprising at least one first part-shell and at least one second part-shell, wherein the part-shells, when assembled, complement each other to form a first ring body of the cable protector ring, which first ring body comprises an inner jacket wall which circumferentially surrounds the power supply line when the cable protector ring is arranged in its installed position on the power supply line.

### BACKGROUND

DE 201 00 947 U1 describes a wear ring for protecting a cable guide hose on a robot, with an inner ring and an outer ring each comprising two half-shells. The half-shells of at least one of the rings can be locked together.

### SUMMARY

The object of the invention is to provide a cable protector ring for a power supply line on a robot arm, which, in the case of its worn condition, can be easily restored with little assembly effort.

The object is achieved by a cable protector ring for a power supply line on a robot arm, comprising at least one first part-shell and at least one second part-shell, wherein the part-shells, when assembled, complement each other to form a first ring body of the cable protector ring, which first ring body comprises an inner jacket wall which circumferentially surrounds the power supply line when the cable protector ring is arranged in its installed position on the power supply line, wherein the first ring body comprises a circumferential seat surface, which is arranged on its outer jacket wall and on which a one-piece, circumferentially closed second ring body is mounted.

The type of cable protector rings in question generally serve to protect a power supply line from substantial damage by keeping the power supply line at a distance from a robot arm or by only allowing contact between the power supply line and the links of the robot arm to a certain extent, substantially only at the cable protector rings, so that on the one hand there are as few collisions as possible between the power supply line and the robot arm or the power supply line primarily only comes into contact with the links of the robot arm via its cable protector rings.

The cable protector rings can be intended for fastening to the power supply line. One or more cable protector rings can therefore be fastened to an outer jacket wall of the power supply line or to a protective hose of the power supply line. However, one or more cable protector rings can also surround the power supply line only circumferentially, without being directly fastened to the power supply line. Thus, the first ring body can generally have an inner jacket wall which surrounds the power supply line circumferentially when the cable protector ring is arranged in its installed position on the power supply line. One or more cable protector rings can, for example, be fastened to a ring or pipe connection piece which surrounds the power supply line, i.e., the power supply line is led through the ring or the pipe connection piece in such a case.

The cable protector rings also form wear bodies that are deliberately designed as contact bodies with the links of the robot arm so that unavoidable collisions, which can also include grinding movements, between the power supply line and the robot arm only occur with the cable protector rings and thus the actual power supply line, in particular its protective hose, is protected from damage and wear. A corresponding power supply line can, for example, be equipped with one, two or more cable protector rings.

A power supply line is understood to mean in particular a power line and/or a power supply, which may comprise lines such as electrical lines, cold and/or hot water lines, fluid and/or pressure lines to tools that are flange-mounted to the robot arm. The power supply line, in particular the power line and/or the power supply, can be combined in individual strands or in cable bundles and in particular can be sheathed with one or more flexible protective hoses, such as corrugated hoses. The cable protector rings can, for example, be fastened to these corrugated hoses.

In order to ensure that the cable protector rings on a power supply line can be completely installed and removed when required, even when the power supply line is mounted on a robot arm, they must generally be designed in at least two parts. The at least two half-shells are usually connected to each other by means of fastening means known per se. These fastening means can be screws or rivets, made of either metal or plastic.

The first ring body can form an inner ring of the cable protector ring, which is concentrically surrounded by a second ring body as an outer ring. The first ring body comprises at least one first part-shell and at least one second part-shell, wherein the part-shells, when assembled, complement each other to form the first ring body of the cable protector ring.

Inventively, the first ring body comprises a circumferential seat surface, which is arranged on its outer jacket wall and on which a one-piece, circumferentially closed second ring body is mounted. In contrast to the first ring body, the second ring body is not made up of multiple parts, but is made up of one part. When assembled, the second ring body surrounds the first ring body circumferentially from the outside. The one-piece second ring body sits on the outer jacket of the first ring body. The second ring body forms the part of the cable protector ring intended for wear, i.e., the actual wear ring.

The multi-part inner ring merely forms a carrier ring with which the entire cable protector ring is fastened to a power supply line.

The outer ring forms the wear ring, which is designed to allow the power supply line to slide over the robot arm as friction-free and wear-free as possible. On the other hand, the second ring body, i.e., the one-piece outer ring or the one-piece wear ring, is intended to provide the wear material required for a certain period of time due to unavoidable wear, so that the multi-piece first ring body, i.e., the carrier ring, is reliably or at least largely prevented from being damaged. The outer ring is designed to be ground down during normal operation on the robot arm in order to protect the links of the robot arm on the one hand and to protect the inner ring or the carrier ring from wear on the other.

Since the first ring body comprises a circumferential seat surface arranged on its outer jacket wall, onto which a one-piece, circumferentially closed second ring body is mounted, repair of a power supply line on a robot arm can be carried out more easily, quickly and cost-effectively.

Firstly, the second ring body, which forms the actual wear ring, comprises no gaps or joints due to its one-piece design. Since there are no gaps or joints on the second ring body, there are no edges or steps which, on the one hand, could be at risk of being subject to increased wear themselves and, on the other hand, the edges or steps could potentially cause increased wear on the surface of the robot arm.

Furthermore, due to the one-piece nature of the second ring body, no fastening means or connecting means are required, which would otherwise be necessary to connect the otherwise multiple parts. Existing fastening means or connecting means also pose a certain risk that they could cause increased wear on the surface of the robot arm. Omitting fastening means or connecting means is also more cost-effective and reduces the variety of parts in production.

In one aspect according to the disclosure, if the wear limit on the cable protector ring is reached, the two-part or multi-part first ring body (carrier ring) can remain on the power supply line and only the worn outer second ring body (wear ring) needs to be replaced. If a worn second ring body is to be removed, it is sufficient to simply pull it off in the axial direction from the first ring body, i.e., the carrier ring. Subsequently, the second ring body pulled off from the first ring body, i.e., the carrier ring, can be pulled off in the axial direction from the power supply line or from the corrugated hose of the power supply line. In this respect, no tools are required to loosen a fastening means or a connecting means so that the second ring body can be removed from the first ring body.

In general, the invention also results in a very economical cable protector ring, since in the event of wear only the outer second ring body has to be replaced and the first ring body can remain on the power supply line, i.e., can continue to be used.

It is particularly easy to remove a worn second ring body from the power supply line because the inner diameter of the second ring body is significantly larger than the outer diameter of the power supply line or the corrugated hose of the power supply line due to the size of the first ring body.

The one-piece, circumferentially closed second ring body can be clamped with frictional engagement onto the circumferential seat surface of the first ring body.

Since the one-piece, circumferentially closed second ring body is clamped with frictional engagement onto the circumferential seat surface of the first ring body, separate fastening means or a connecting means can be omitted, i.e., in particular for removing the second ring body from the first ring body, no tools for loosening fastening means or a connecting means are required.

The one-piece, circumferentially closed second ring body can be made of an elastomeric material. If the second ring body is made of an elastomeric material, it has an internal elasticity of the second ring body itself and no separate clamping devices are required. The elastomeric material can be, for example, a polyurethane, a natural rubber or a silicone rubber.

The elasticity of the second ring body can be adjusted by the appropriate selection of a specific elastomeric material for the second ring body. The elasticity of the second ring body should, for example, be adjusted on the one hand with a view to achieving the highest possible adhesion of the second ring body to the first ring body and on the other hand with a view to making it as easy as possible to (manually) remove the second ring body from the first ring body. A high adhesive force of the second ring body on the first ring body should ensure that the second ring body does not come loose accidentally during operation of the power supply line on the robot arm when the cable protector ring drags along the robot arm, but remains reliably on the first ring body due to the clamping force. Easy (manual) removal is intended to ensure that the second ring body can be axially stiffened from the first ring body by one person without special tools, if necessary manually, so that the second ring body can be easily removed in the event of wear or a new second ring body can be easily pushed axially onto the first ring body.

The one-piece, circumferentially closed second ring body may comprise a hollow cross-section. By using a hollow cross-section, a relatively high (radial) elasticity can be achieved in the second ring body, even if the material for the second ring body comprises a rather low elasticity or a relatively high stiffness. The elasticity in the cross-section can then be adjusted by suitable selection of the outer diameter of the second ring body relative to the inner diameter of the hollow channel of the second ring body.

As an alternative to a hollow cross-section, the second ring body can also be made of solid material. The solid material can then in particular be a softer material than a corresponding material in a second ring body with a hollow cross-section.

The one-piece, circumferentially closed second ring body may have a circular cross-section.

If the one-piece, circumferentially closed second ring body has a circular cross-section, then the circumferential seat surface of the first ring body can be shaped in the manner of a fillet. The fillet then comprises a radius of curvature that matches the diameter of the second ring body.

Especially if the first ring body is designed to be rotatable around the hose outer jacket wall of the power supply line, it can be expedient if the one-piece, circumferentially closed second ring body has a circular cross-section. In particular, when the first ring body is rotatably mounted on the hose outer jacket wall of the power supply line, there is a very small risk that the second ring body with a circular cross-section will be pulled off the first ring body in an undesirable manner if the second ring body drags over the robot arm during operation.

The one-piece, circumferentially closed second ring body may have a circular segment-shaped cross-section.

In the case of a one-piece, circumferentially closed second ring body with a circular segment-shaped cross-section, the cross-sectional contour of the second ring body comprises an arcuate, i.e., convex, outer wall portion and a straight, i.e., forming the chord of the circular segment-shaped cross-section, inner wall portion. When assembled, the inner wall portion faces the first ring body, i.e., the straight inner wall portion rests on the circumferential seat surface of the first ring body. The convex outer wall portion forms the actual wear surface of the second ring body or the entire cable protector ring.

The inner jacket wall of the one-piece, circumferentially closed second ring body may have at least one recessed groove and the circumferential seat surface of the outer jacket wall of the first ring body may have a ring projection corresponding to the recessed groove of the one-piece, circumferentially closed second ring body, which ring projection, when the one-piece, circumferentially closed second ring body is in the assembled state on the first ring body, engages form-fittingly in the recessed groove of the one-piece, circumferentially closed second ring body.

By means of the at least one recessed groove and the corresponding at least one ring projection, the assembly of the first ring body and the second ring body receives additional axial fixation. The recessed groove together with the ring projection also forms a guide to ensure the exact installed position of the second ring body on the first ring body.

The circumferential seat surface of the outer jacket wall of the first ring body can be designed to simultaneously accommodate at least one first one-piece, circumferentially closed second ring body and at least one second one-piece, circumferentially closed second ring body.

The circumferential seat surface of the first ring body can therefore be shaped such that, instead of just a single second ring body, two, three, four or even more second ring bodies can be mounted on the same first ring body.

Each of the multiple one-piece, circumferentially closed second ring bodies can lie in an associated ring recess of the common first ring body. The multiple ring recesses and the multiple one-piece, circumferentially closed second ring bodies can each extend parallel to one another over the circumference of the first ring body. The multiple one-piece, circumferentially closed second ring bodies can be arranged axially spaced from one another.

The first ring body can have fastening means which are designed for the rotationally and axially fixed clamping of the first ring body to a hose outer jacket wall of a power supply line.

The first ring body can have bearing means which are designed for rotatable bearing about a center axis of the first ring body and for axially fixing the first ring body to a hose outer jacket wall of a power supply line.

Specific embodiments of the invention are explained in more detail in the following description with reference to the accompanying drawings. Specific features of these embodiments, possibly considered individually or in further combinations, can represent general features of the invention, regardless of the specific context in which they are mentioned.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a perspective view of an exemplary robot arm with a power supply line and associated cable protector rings,

FIG. 2 is an enlarged perspective view of a portion of the power supply line in the region of a first exemplary embodiment of a cable protector ring,

FIG. 3 is a schematic representation of the cable protector ring according to FIG. 2 with the one-piece second ring body removed from the two-piece first ring body,

FIG. 4 is an exploded view of the cable protector ring according to FIG. 2,

FIG. 5 is a cross-sectional view of the cable protector ring according to FIG. 2,

FIG. 6 is a schematic representation of a second exemplary embodiment of a cable protector ring with a rotatably mounted two-part first ring body and a one-part second ring body with a circular cross-section,

FIG. 7 is a schematic representation of the cable protector ring according to FIG. 6 with the one-piece second ring body removed from the two-piece first ring body,

FIG. 8 is an exploded view of the cable protector ring according to FIG. 6,

FIG. 9 is a partial cross-sectional view of the cable protector ring according to FIG. 6,

FIG. 10 is a schematic representation of a third exemplary embodiment of a cable protector ring with a two-part first ring body and multiple one-part second ring bodies with a circular cross-section, and

FIG. 11 is a cross-sectional view of the cable protector ring according to FIG. 10.

### DETAILED DESCRIPTION

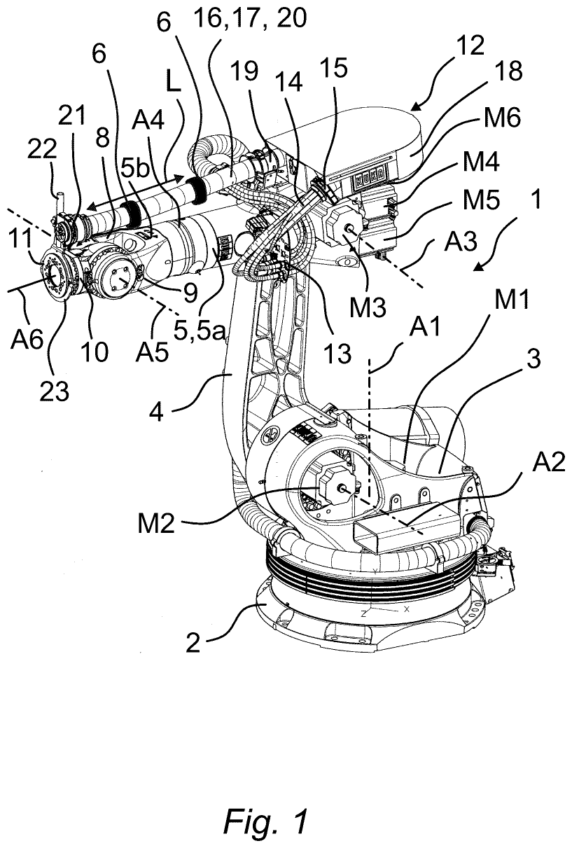

FIG. 1 shows an industrial robot 1 with a base frame 2 on which a carousel 3 is mounted so as to be rotatable about a first vertical axis A1 and is rotationally driven by means of a first drive motor M1. On the carousel 3, a link arm 4 is mounted so as to be pivotable up and down about a second horizontal axis A2, and is driven in rotation by means of a second drive motor M2. The link arm 4 carries a robot arm 5, which in this case is formed as an arm extension 5a and is mounted so as to be pivotable up and down about a third horizontal axis A3 and is rotationally driven by means of a third drive motor M3. A fourth axis A4 is provided on the arm extension 5a and runs in the longitudinal extent of the arm extension 5a and drives in rotation a hand 5b of the arm extension 5a via a fourth drive motor M4. A first limb 8 and a second limb 9 extend forward in a fork shape from the hand 5b. The two limbs 8 and 9 carry a bearing for a free end 10 of the hand 7. The bearing defines a fifth axis A5 of the industrial robot 1, about which the hand 5b can be pivotably moved by means of a fifth drive motor M5. In addition, the hand 5b comprises a sixth axis A6 in order to be able to rotatably drive a fastening flange 11 by means of a sixth drive motor M6.

The arm extension 5a carries a power supply device 12. The power supply device 12 begins behind a connection plate 13, which is firmly connected to the arm extension 5a of the industrial robot 1. Individual lines 14 lead from the connection plate 13 to a clamp 15. The clamp 15 is fastened to a casing 18 of the power supply device 12. The clamp 15 clamps the individual lines 14 and fixes them in a fixed position with respect to the casing 18. A power supply line 17 of the power supply device 12 is guided in a U-shape in the casing 18 of the power supply device 12 in a spring-loaded manner. In the U-shaped portion and on the outlet side after a sliding guide 19 which is fixed with respect to the casing 18, the individual lines 14 are combined in the common line harness 16, in particular protected by a protective hose 20. The protective hose 20 ends at a holding device 21. The holding device 21 can, as shown, for example, be held at a distance from the arm extension 5a by means of a hose holder 22. The hose holder 22 can be fastened to the fastening flange 11 of the industrial robot 1 by a two-part clamp bracket 23. In the case of the present embodiment, the power supply line 17, in particular its protective hose 20, is equipped with multiple, in particular as shown with two, inventive cable protector rings 6.

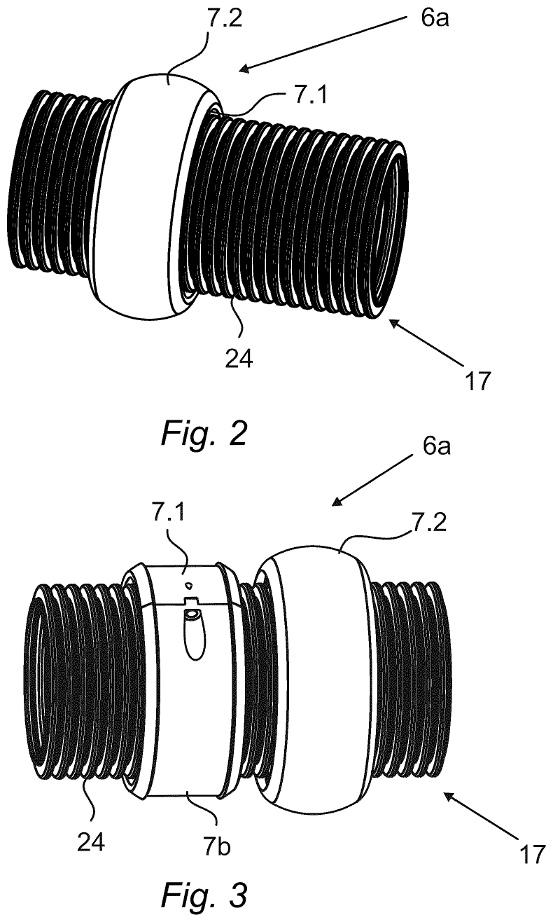

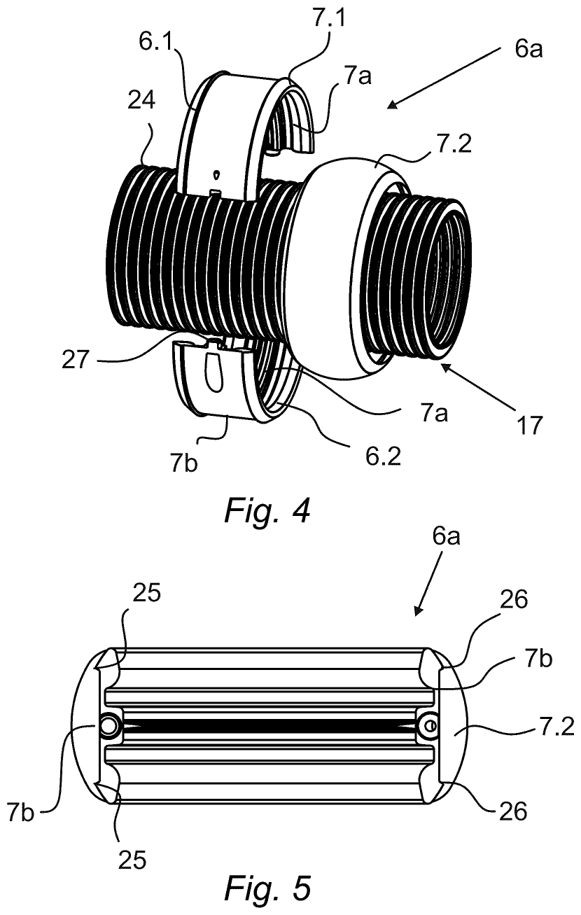

FIG. 2 to FIG. 5 show an exemplary cable protector ring 6a in a first embodiment for a power supply line 17 on a robot arm 5.

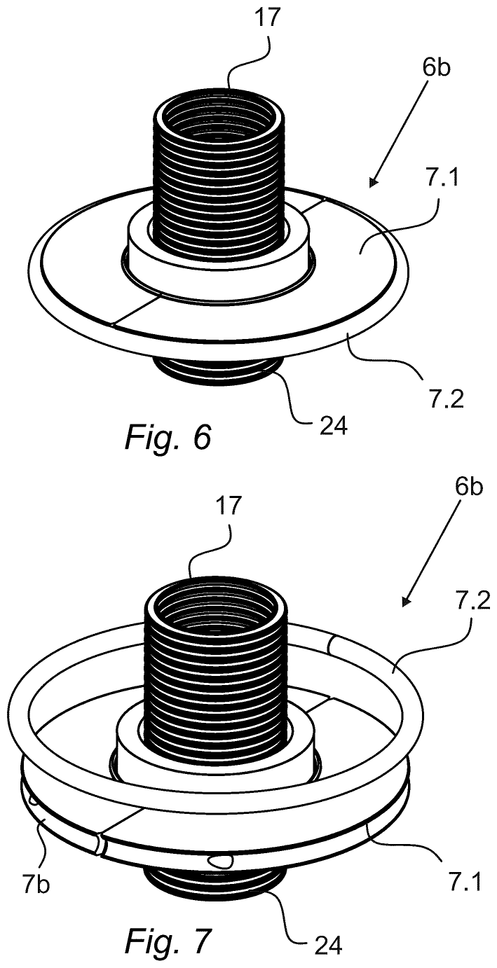

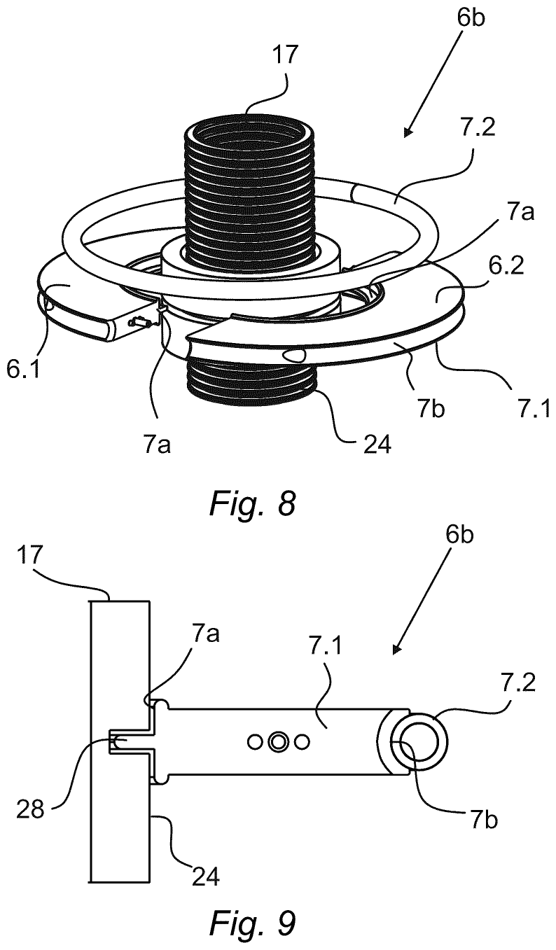

FIG. 6 to FIG. 9 show an exemplary cable protector ring 6b in a second embodiment for a power supply line 17 on a robot arm 5.

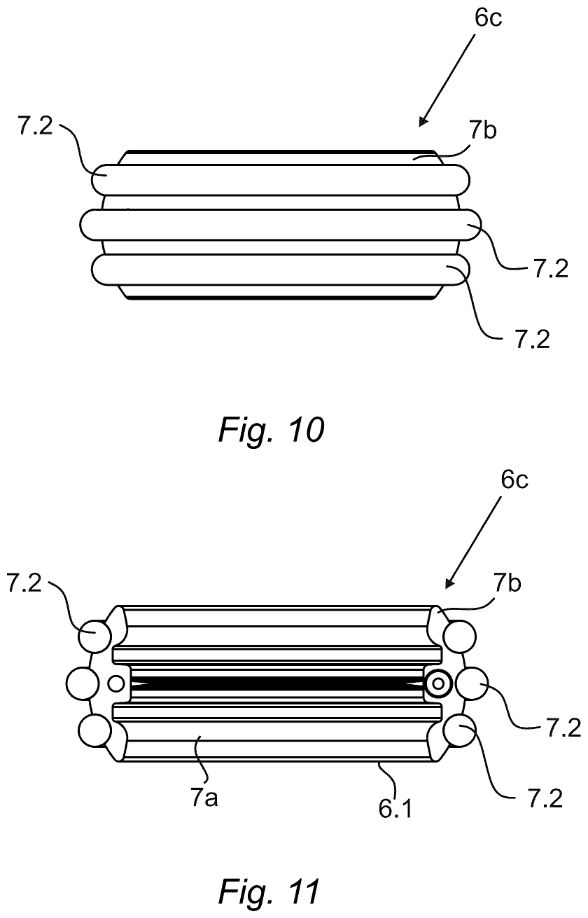

FIG. 10 and FIG. 11 show an exemplary cable protector ring 6c in a third embodiment for a power supply line 17 on a robot arm 5.

The relevant cable protector ring 6a, 6b, 6c comprises at least one first part-shell 6.1 and at least one second part-shell 6.2, wherein the part-shells 6.1, 6.2, when assembled, complement each other to form a first ring body 7.1 of the cable protector ring 6a, 6b, 6c, which first ring body 7.1 comprises an inner jacket wall 7a which forms a contact surface for a hose outer jacket wall 24 of the power supply line 17 when the cable protector ring 6a, 6b, 6c is fastened to the power supply line 17 in its installation position.

The first ring body 7.1 comprises a circumferential seat surface 7b, which is arranged on its outer jacket wall and on which at least one one-piece, circumferentially closed second ring body 7.2 is mounted.

The one-piece, circumferentially closed second ring body 7.2 can in particular be clamped with frictional engagement onto the circumferential seat surface 7b of the first ring body 7.1.

The one-piece, circumferentially closed second ring body 7.2 can in particular be made of an elastomeric material.

In the case of the second embodiment according to FIG. 6 to FIG. 9, the one-piece, circumferentially closed second ring body 7.2 with a hollow cross-section is shown. In other embodiments, not shown, in particular in the first embodiment according to FIG. 2 to FIG. 5 and in the third embodiment according to FIG. 10 and FIG. 11, however, the one-piece, circumferentially closed second ring body 7.2 can also be designed with a hollow cross-section.

As for the second embodiment according to FIG. 6 to FIG. 9 and the third embodiment according to FIG. 10 and FIG. 11, the one-piece, circumferentially closed second ring body 7.2 comprises a circular cross-section.

As in the first embodiment according to FIG. 2 to FIG. 5, the one-piece, circumferentially closed second ring body 7.2 may comprise a circular segment-shaped cross-section.

Specifically in the cross-sectional view of FIG. 5 it is shown how the inner jacket wall of the one-piece, circumferentially closed second ring body 7.2 comprises at least one recessed groove 25 (in the case of the exemplary embodiment shown, two grooves 25) and the circumferential seat surface 7b of the outer jacket wall of the first ring body 7.1 comprises a ring projection 26 corresponding to the relevant recessed groove 25 of the one-piece, circumferentially closed second ring body 7.2, which, in the assembled state of the one-piece, circumferentially closed second ring body 7.2 on the first ring body 7.1, engages form-fittingly in the recessed groove 25 of the one-piece, circumferentially closed second ring body 7.2.

In the third embodiment according to FIG. 10 and FIG. 11, the circumferential seat surface 7b of the outer jacket wall of the first ring body 7.1 is designed to simultaneously accommodate at least one first one-piece, circumferentially closed second ring body 7.2 and at least one second one-piece, circumferentially closed second ring body 7.2, in particular to accommodate three pieces of one-piece, circumferentially closed second ring bodies 7.2. Each of the three one-piece, circumferentially closed second ring bodies 7.2 lies in an associated ring recess of the first ring body 7.1. The ring recesses and the multiple one-piece, circumferentially closed second ring bodies 7.2 extend parallel to each other over the circumference of the first ring body 7.1. The multiple one-piece, circumferentially closed second ring bodies 7.2 are arranged axially spaced from one another.

For example, in the first embodiment according to FIG. 2 to FIG. 5, the first ring body 7.1 may comprise fastening means 27 which are designed for the rotationally and axially fixed clamping of the first ring body 7.1 to the hose outer jacket wall 24 of the power supply line 17.

For example, in the second embodiment according to FIG. 6 to FIG. 9, the first ring body 7.1 may comprise bearing means 28 which are designed for rotatable mounting about a center axis of the first ring body 7.1 and for axially fixing the first ring body 7.1 to the hose outer jacket wall 24 of the power supply line 17.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

1. Line protector ring for a power supply line (17) on a robot arm (5), comprising at least one first part-shell (6.1) and at least one second part-shell (6.2), wherein the part-shells (6.1, 6.2), when assembled, complement each other to form a first ring body (7.1) of the line protector ring (6), which first ring body (7.1) comprises an inner jacket wall (7a), which circumferentially surrounds the power supply line (17) when the line protector ring (6) is arranged in its installed position on the power supply line (17), characterized in that the first ring body (7.1) comprises a circumferential seat surface (7b), which is arranged on its outer jacket wall and on which at least one one-piece, circumferentially closed second ring body (7.2) is mounted.

2-10. (canceled)

11. Line protector ring according to claim 1, characterized in that the one-piece, circumferentially closed second ring body (7.2) is clamped with frictional engagement onto the circumferential seat surface (7b) of the first ring body (7.1).

12. Line protector ring according to claim 1, characterized in that the one-piece, circumferentially closed second ring body (7.2) is made of an elastomeric material.

13. Line protector ring according to claim 1, characterized in that the one-piece, circumferentially closed second ring body (7.2) comprises a hollow cross-section.

14. Line protector ring according to claim 1, characterized in that the one-piece, circumferentially closed second ring body (7.2) has a circular cross-section.

15. Line protector ring according to claim 1, characterized in that the one-piece, circumferentially closed second ring body (7.2) has a circular segment-shaped cross-section.

16. Line protector ring according to claim 15, characterized in that the inner jacket wall of the one-piece, circumferentially closed second ring body (7.2) comprises at least one recessed groove (25) and the circumferential seat surface (7b) of the outer jacket wall of the first ring body (7.1) comprises a ring projection (26) corresponding to the recessed groove (25) of the one-piece, circumferentially closed second ring body (7.2), which ring projection, in the assembled state of the one-piece, circumferentially closed second ring body (7.2) on the first ring body (7.1), engages form-fittingly in the recessed groove (25) of the one-piece, circumferentially closed second ring body (7.2).

17. Line protector ring according to claim 1, characterized in that the circumferential seat surface (7b) of the outer jacket wall of the first ring body (7.1) is designed to simultaneously accommodate at least one first one-piece, circumferentially closed second ring body (7.2) and at least one second one-piece, circumferentially closed second ring body (7.2).

18. Line protector ring according to claim 1, characterized in that the first ring body (7.1) comprises fastening means (27) which are designed for the rotationally fixed and axially fixed clamping of the first ring body (7.1) to a hose outer jacket wall (24) of a power supply line (17).

19. Line protector ring according to claim 1, characterized in that the first ring body (7.1) comprises bearing means (28) which are designed for rotatable bearing about a center axis of the first ring body (7.1) and for axially fixing the first ring body (7.1) to a hose outer jacket wall (24) of a power supply line (17).
